(19) United States
(12) Patent Application Publication
(10) Pub. No.: US 2024/0365116 A1
(43) Pub. Date: Oct. 31, 2024

(54) SELF-PROVISIONING IN A PRIVATE CELLULAR ENTERPRISE NETWORK

(71) Applicant: Dell Products L.P., Round Rock, TX (US)

(72) Inventors: David Lake, Crawley (GB); Jeffrey Goldberg, Raanana (IL)

(21) Appl. No.: 18/307,726

(22) Filed: Apr. 26, 2023

(51) Int. Cl. H04W 12/06; H04W 8/26; H04W 12/72

(52) U.S. Cl. CPC H04W 12/06; H04W 8/26; H04W 12/72

(57) ABSTRACT

One example method includes receiving at a core enterprise network of a private cellular network a device identifier from devices that are to interact with the core enterprise network that do not include a Subscriber Identity Module (SIM). Based on the device identifier, the devices are attached to the core enterprise network. Subsequent to attaching the devices, the devices are provided a limited access portal that receives user authentication credentials from the devices. The user authentication credentials are received from the devices and the user authentication credentials are used to authenticate the devices. When the user authentication credentials are authenticated by the core enterprise network the devices are provided with full access to the network services of the core enterprise network. Then interactions between the core enterprise network and the devices are done using the transmit and receive infrastructure of the private cellular network.

### FIELD OF THE INVENTION

Embodiments of the present invention generally relate to systems, hardware, software, computer-readable media, and methods for provisioning a device in a private cellular network.

### BACKGROUND

In public cellular networks, users are provisioned using SIMs (both physical and eSIM) which links their service to the network. Prior to the installation of this device, the user has no access to the network and physical interaction, either installing a SIM or connecting to a Wi-Fi network and downloading an eSIM, is required.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIGS. 1A-1C disclose aspects of public cellular network.

FIG. 2 discloses aspects of a public access network.

FIG. 3A discloses aspects of a private cellular network.

FIG. 3B discloses an embodiment of the private cellular network of FIG. 3A.

FIG. 3C discloses an embodiment of the private cellular network of FIG. 3A.

FIG. 3D discloses an embodiment of the private cellular network of FIG. 3A.

FIG. 4 discloses a flowchart of an example method for provisioning a device in a private cellular network.

FIG. 5 illustrates an example computing entity operable to perform any of the disclosed methods, processes, and operations.

### DETAILED DESCRIPTION OF SOME EXAMPLE EMBODIMENTS

Embodiments of the present invention generally relate to systems, hardware, software, computer-readable media, and methods for provisioning a device in a private cellular network.

In general, example embodiments of the invention include receiving at a core enterprise network of a private cellular network a device identifier from devices that are to interact with the core enterprise network that do not include a Subscriber Identity Module (SIM). Based on the device identifier, the devices are attached to the core enterprise network. Subsequent to attaching the devices, the devices are provided a limited access portal that receives user authentication credentials from the devices. The user authentication credentials are received from the devices and the user authentication credentials are used to authenticate the devices. When the user authentication credentials are authenticated by the core enterprise network the devices are provided with full access to the network services of the core enterprise network. Then interactions between the core enterprise network and the devices are done using the transmit and receive infrastructure of the private cellular network.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. Also, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer- implemented.

A. Aspects of A Public Cellular Network

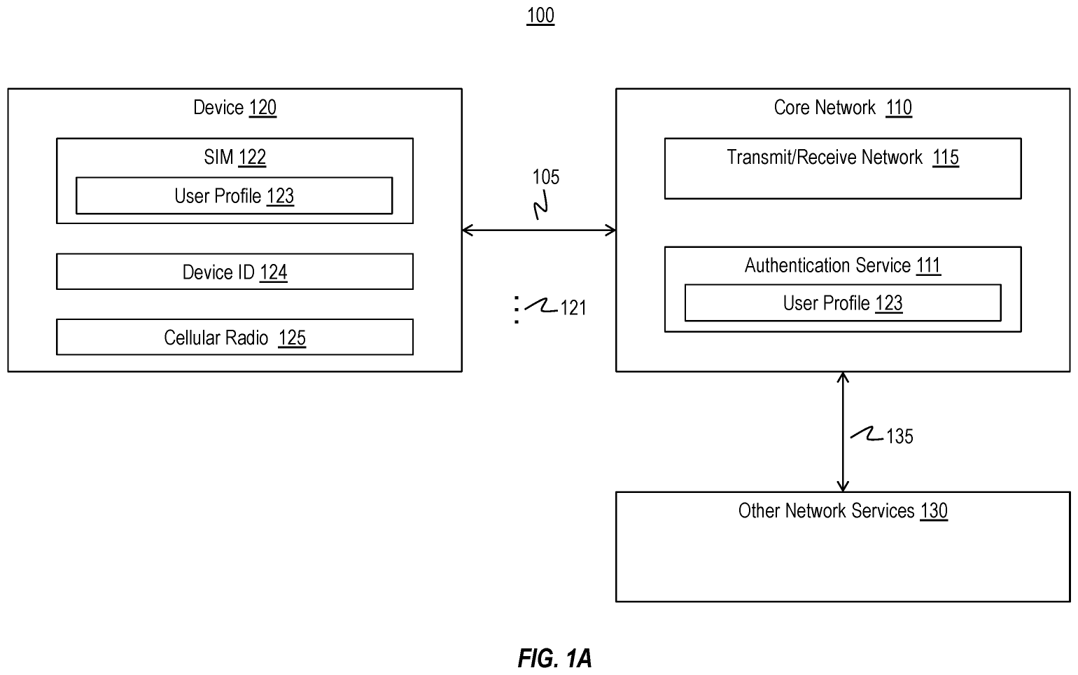

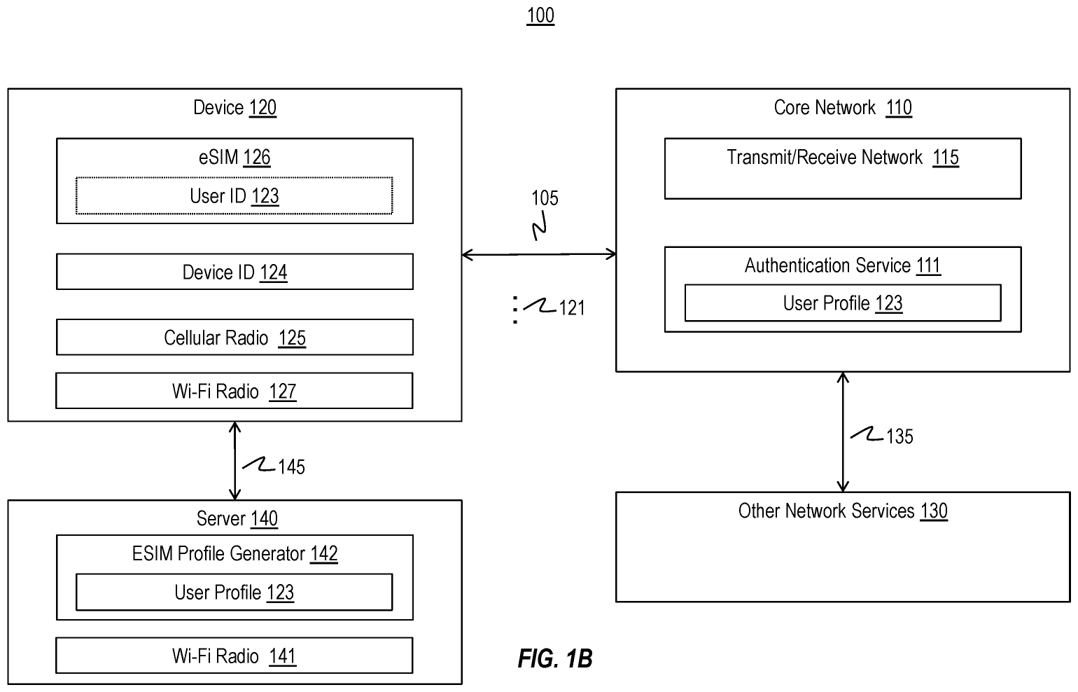

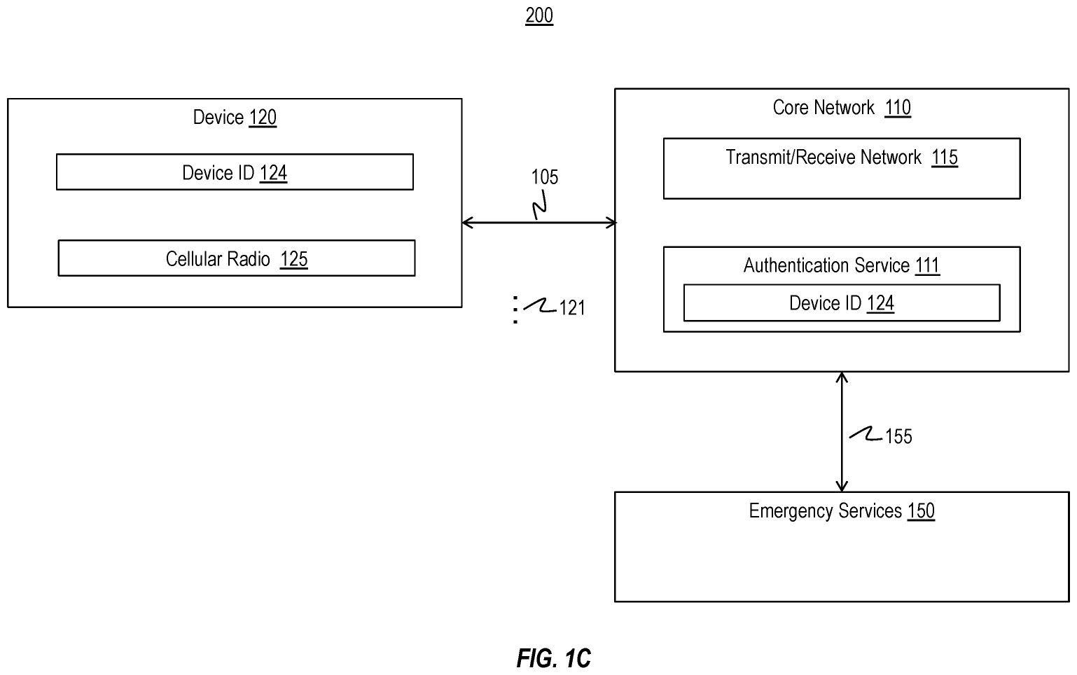

FIG. 1A illustrates aspects of an embodiment of a public cellular network 100. The public cellular network 100 may be any reasonable public cellular network such as those implementing the 3GPP standard, including a 4G LTE network or a 5G network. The public cellular network 100 includes a core network 110. The core network 110 is a simplified representation of all of the hardware modules and software modules of the public cellular network 100 that allows various devices (i.e., mobile terminals) such as a device 120 to communicate via the public cellular network and thus need not be explained in great detail. In particular, the core network 110 includes a transmit/receive network 115 that represents the physical transmit/receive infrastructure of the core network such as the various base stations and/or radios such as a 4G LTE or 5G radio. In addition, the core network 110 includes an authentication service 111 such as a Home Subscriber Service (HSS) that is used by the core network 110 to authenticate a device to the public cellular network as will be explained.

As illustrated, the public cellular network 100 includes a device 120 and may include any number of additional devices 121 as illustrated by the ellipses. The devices 120 and 121 may be a mobile phone, a laptop computer, a tablet computer, or any other device that is able to communicate with the core network 110 using the transmit/receive network 115. These other devices include devices that are not normally thought of as computing devices such as office devices like a printer or copier or machinery like a forklift or an autonomous robot in a smart warehouse.

FIG. 1A illustrates the device 120, but it will be appreciated that the description of device 120 may apply to the additional devices 121. As illustrated, the device 120 includes a radio 125 that allows the device to communicate with the core network 110 using the transmit/receive network 115. For example, if the transmit/receive network 115 supported 5G, and the device 120 was configured for 5G communication, then the radio 125 would be a radio that would support at least 5G.

The device 120 also includes a Subscriber Identity Module (SIM) 122, which is typically a removable physical smart card that is installed in the device 120. The SIM 122 is typically provided by an owner or operator of the core network 110 and is used to authenticate the device 120 to the core network 110 so that the device 120 can utilize the core network 110 to access the services of the other networks 130 such as the internet or public phone system. Thus, only devices that have a SIM provided by the owner or operator of the core network 110 are typically able to use the full functionality of the core network 110. Accordingly, the SIM 122 includes a user profile 123, which may include International Mobile Subscriber Identity (IMSI) that uniquely identifies the user of the device 120 and other data such as public keys and like, that is used by the core network 110 to authenticate and authorize the user of the device 120 to use the core network 110. The user of the device 120 also includes a device identifier 124, such as the International Mobile Equipment Identity (IMEI) that is specific to the device 120.

When the device 120 is tuned on, a signal represented by 105 is transmitted from the device 120 to the core network 110 that includes the user profile 123 of the SIM 122. The authentication service 111 then verifies if the user profile 123 is registered with the core network 110. If the user profile 123 is registered, as is the case in the present embodiment as represented by the authentication service 111 having a record of the user profile 123, then the device 120 is authenticated and is able to use the core network 110 to access the services of the other networks 130 such as the internet as denoted at 135. This process is repeated anytime the device 120 is powered on and is within a service area of the core network 110.

FIG. 1B illustrates aspects of an alternative embodiment of the public cellular network 100. Accordingly, those elements described in relation to FIG. 1A need not be described again. As illustrated in FIG. 1B, the device 120 does not include the SIM 122 and so is not able to use the core network 110 to access the services of the other networks 130.

The device 120, however, does include an embedded-SIM (eSIM) 126. The eSIM 126 is a circuit structure and software that is able to receive a profile, such as the user profile 123, that is then programmed into the eSIM. Once programmed with the SIM profile, also referred to as an “eSIM profile”, the eSIM functions the same as a physical SIM and allows the device 120 to communicate with the core network 110. However, before it receives the eSIM profile, the eSIM 126 does not function as a SIM.

As also illustrated, the device 120 includes a Wi-Fi radio 127 that allows the device 120 to connect with and communicate over a Wi-Fi network. Accordingly, as shown at 145 the device 120 is able to connect to a server 140 using having a Wi-Fi radio 141 over the Wi-

Fi network. The server 140 is typically owned by or authorized by the owner or operator of the core network 110 and, although shown as being separate, may be part of the core network 110. The server 140 includes an eSIM profile generator 142 that is able to generate an eSIM profile to be used by the eSIM 126. Accordingly, the eSIM profile generator generates an eSIM profile 123, which may include International Mobile Subscriber Identity (IMSI) that uniquely identifies the user of the device 120 and other data such as public keys and like, that is used by the core network 110 to authenticate and authorize the user of the device 120 to use the core network 110. As shown at 146, the server 140 is able to provide the eSIM user identifier 123 to the eSIM 126. The eSIM profile 123 is shown as a dashed line to indicate that it was not originally present in the eSIM 126 but was programmed into the eSIM after being received from the server 140.

Accordingly, the device 120 is able to use the radio 125 to provide the eSIM user identifier 123 to the core network 110 in the manner described for SIM 122 and thus gain access to use the core network 110 to access the services of the other networks 130. It will be appreciated that in the embodiment of FIG. 1B, the device 120 had to first use the Wi-Fi network to obtain the eSIM user identifier 123 before the device could use the core network 110.

FIG. 1C illustrates aspects of a further alternative embodiment of the public cellular network 100. Accordingly, those elements described in relation to FIG. 1A need not be described again. As illustrated in FIG. 1C, the device 120 does not include the SIM 122 and so is not able to use the core network 110 to access the services of the other networks 130.

However, in the embodiment of FIG. 1C, the device 120 provides the device identifier 124 to the core network 110 as part of an attach request as shown at 105. The authentication service 111 then verifies if the device identifier 124 is registered with the core network 110. If the device identifier 124 is registered, as is the case in the present embodiment as represented by the authentication service 111 having a record of the device identifier 124, then the device 120 is authenticated to use the core network 110 on a very limited basis. This is often referred to as an “attach”. A common example of an attach is an “emergency attach”, which is where the owner or operator of the core network 110 allows a device 120 without a SIM to use the core network to access emergency services 150 as shown at 155, for example a call to 911 in the United States, for authorities such as the police or fire department that can respond to the emergency. It will be appreciated that in an attach situation, it is up to the owner or operator of the core network 110 to decide how much access should be given to the device 120 and in theory full use of the core network 110 could be granted. In the emergency attach situation, only access to emergency authorities is given.

B. Aspects of a Public Access Enterprise

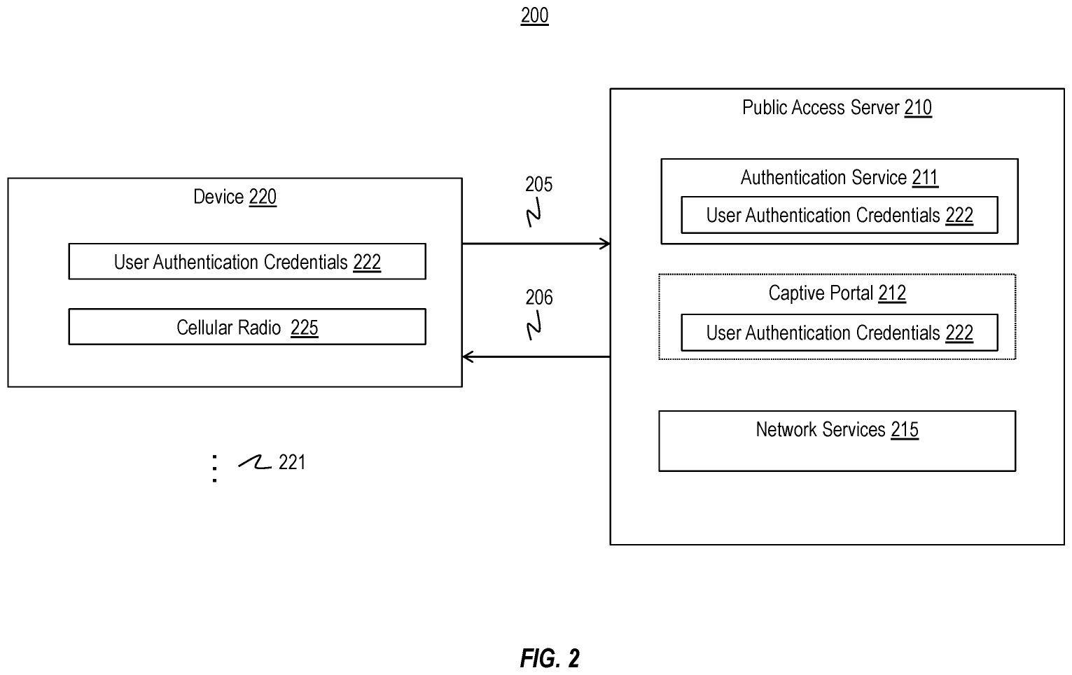

FIG. 2 illustrates aspects of a public access network 200. As illustrated, the public access network includes a public access server 210 that connects to or communicates with various devices using a Wi-Fi network. Once connected, the public access server 210 allows the devices to access various services 215 such as the internet or other applications and services that are directly provided by the public access server 210 the connected devices.

FIG. 2 also illustrates a device 220 and may include any number of additional devices 221 as illustrated by the ellipses. The devices 220 and 221 may be a mobile phone, a laptop computer, a tablet computer, or any other device that is able to communicate with the enterprise server 210 using the Wi-Fi network. Thus, the device 220 includes a Wi-Fi radio 225 that allows the device to connect to a Wi-Fi network. FIG. 2 illustrates the device 220, but it will be appreciated that the description of device 220 may apply to the additional devices 221.

In operation, the device 220 connects with the public access server 210 using the Wi- Fi radio 225 as shown at 205 so as to access the services such as the internet provided by the enterprise server over the Wi-Fi network. Upon connection, the public access server 210 provides a “captive portal” 212 to the device 220, which limits access to the device 220 to only a logon portal. Thus, while in the captive portal, the device 220 cannot access the network services 215 of the public access server 210. The captive portal 212 allows the device 220 to provide user authentication credentials 222 to the public access server 210 to authenticate the device. The user authentication credentials 222 may include a username or an email address and a password that are specific to the user of the device 220. Alternatively, the user authentication credentials 222 may include an enterprise certificate generated by the public access server 210. An authentication service 211 of the public access server 210 verifies that the user authentication credentials 222 were either previously registered with the public access server 210 or are of a type that is acceptable by the public access server 210. In the present embodiment, the user authentication credentials 222 were previously registered as represented by the authentication service 211 having a record of user authentication credentials 222.

Once the device 220 has been authenticated by the public access server 210, the device 220 is released from the captive portal 212. As shown at 206, the device 220 is then able to fully access the network services 215 of the public access server 210 such as access to the internet using the Wi-Fi network.

C. Aspects of A Private Cellular Network

Today, most companies or other like entities deploy a Wi-Fi based network as the primary network infrastructure in a business location such as an office or a warehouse. Such networks may include one or more Wi-Fi routers and access points so that devices used by employees of the business may access the network to access services provided by the company.

With the advent of faster cellular networks, such as 4G LTE, 5G, and perhaps even faster next generation cellular networks, it is now possible for the company to implement a private cellular network as the network infrastructure in the business location. Such private cellular networks offer speeds and bandwidths that are better than those offered by a Wi-Fi network. Thus, the companies need only implement the private cellular network without also implementing a Wi-Fi network, thus saving the costs and time of installing and maintaining two separate networks.

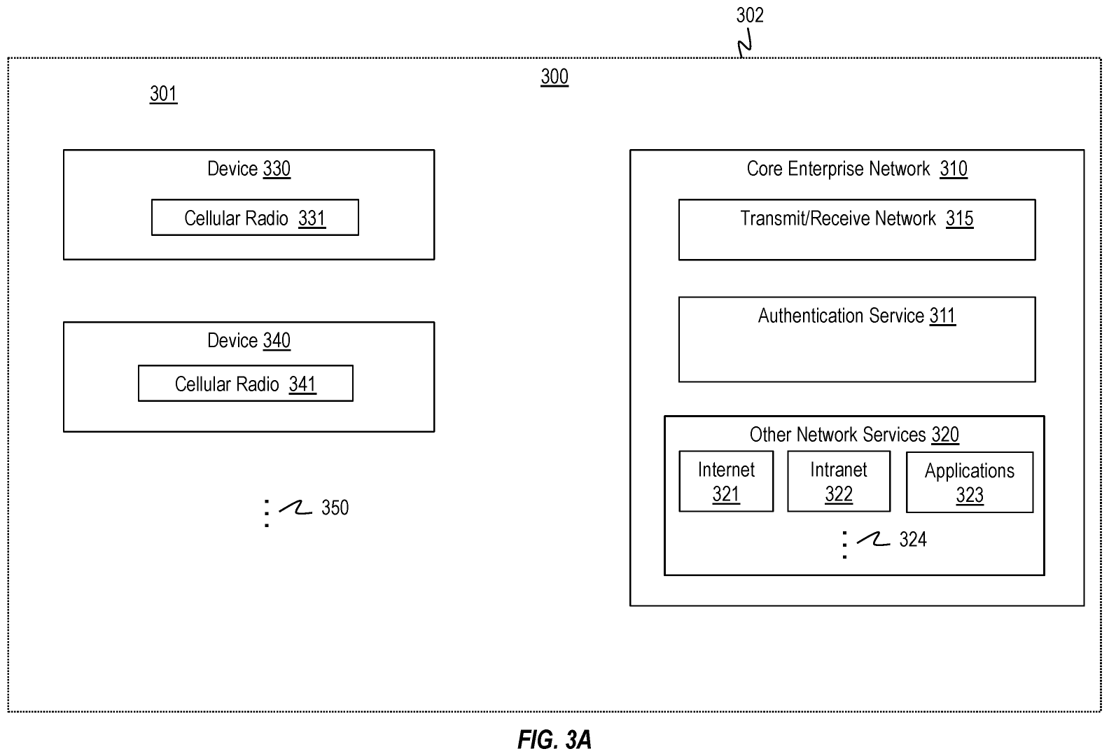

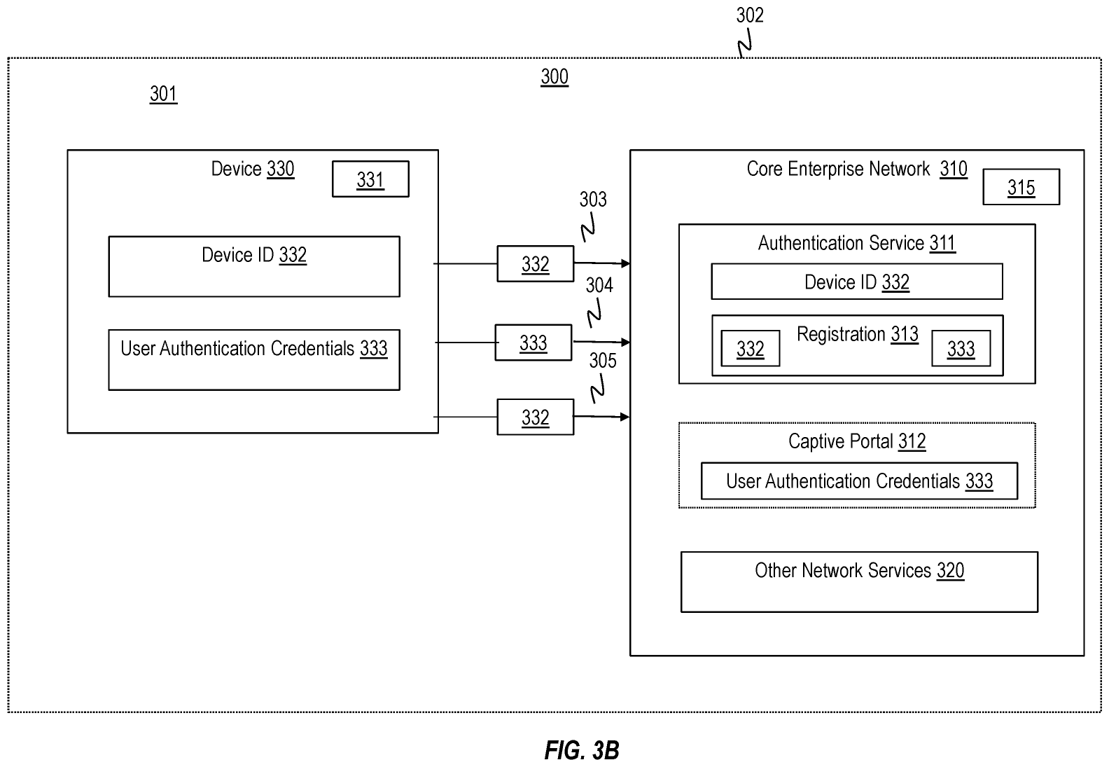

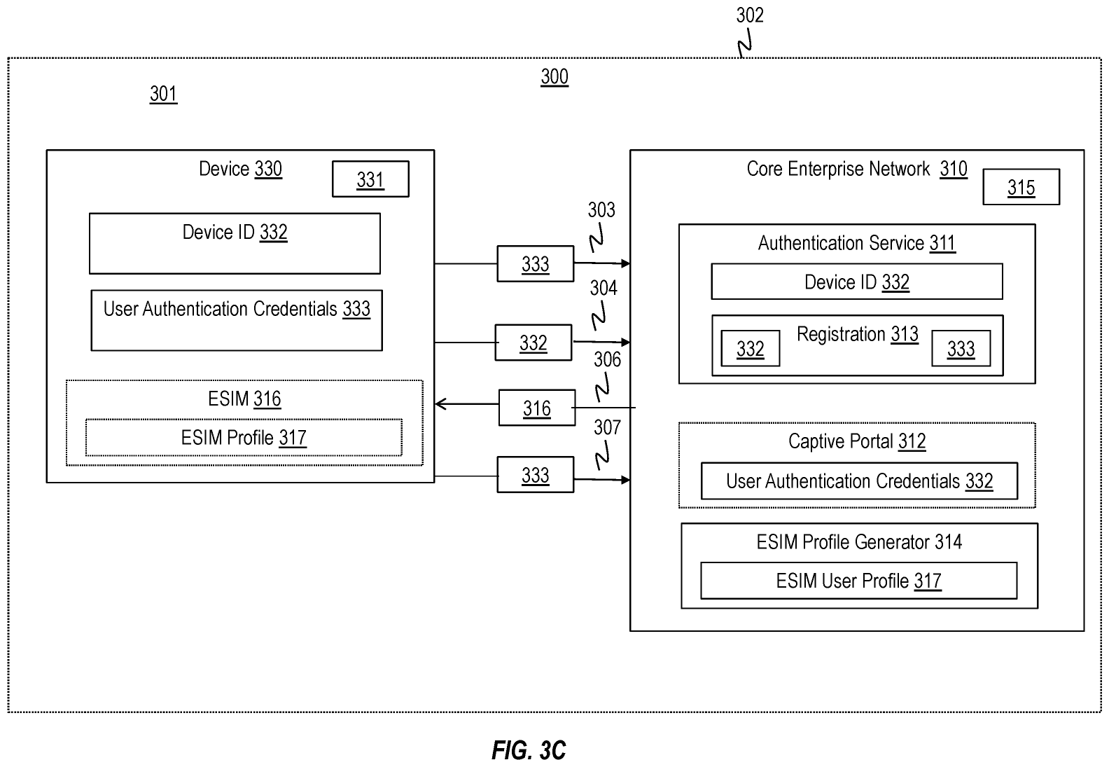

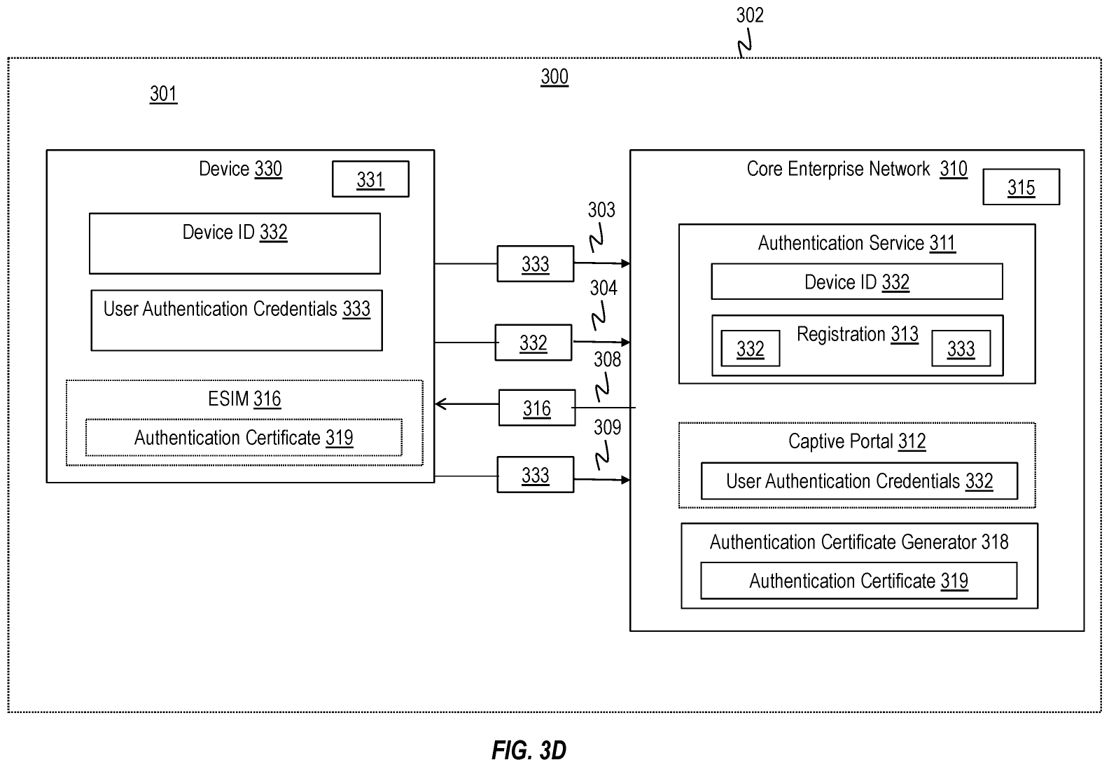

FIG. 3A illustrates an embodiment of a private cellular network 300. As used herein, a private cellular network is any cellular network that follows the 3GPP standard such as 4G LTE and 5G, as well as other now existing or to be developed standards that is limited in use to a specific location such as a business location or to a specific entity such as a business entity and that is not available to a large segment of the public in the manner that a public cellular network in available to large segment of the public. Thus, as illustrated in FIG. 3A the dashed line is to indicate that the private cellular network 300 is deployed at a business location 302 such as a building or warehouse of a specific business entity 301. Accordingly, the embodiments and claims disclosed herein are not limited to any specific implementation of a private cellular network.

As illustrated in FIG. 3A, the private cellular network 300 includes a core enterprise network 310. The core enterprise network 310 is a simplified representation of all of the hardware modules and software modules of the private cellular network 300 that allows various devices to communicate via the private cellular network and thus need not be explained in great detail. In particular, the core enterprise network 310 includes a transmit/receive network 315 that represents the physical transmit/receive infrastructure of the core enterprise network such as the various radios such as a 4G LTE or 5G radio. Since the private cellular network 300 is limited to the business location 302, there may only need to be one or perhaps a small number of radios implemented as this small number will typically be sufficient to cover the business location 302.

In addition, the core enterprise network 310 includes an authentication service 311 such as a Home Subscriber Service (HSS) that is used by the core enterprise network 310 to authenticate a device to the public cellular network as will be explained. Once a device is authenticated by the authentication service 311, the core enterprise network 310 allows access to a device of the various other services 320 provided by core enterprise network. The other services 320 may include internet access 321, access to an intranet 322 of the business entity 301, access to various applications 323 supported by the business entity 301 for the use of the business entity and its employees and/or customers, and any number of additional services 324 as illustrated by the ellipses.

As also illustrated in FIG. 3A, the private cellular network 300 includes various devices such as a device 330, a device 340, and any number of additional devices 350 as illustrated by the ellipses. In the embodiment, the device 330 may be a device of an employee of the business entity 301 who works at the business location 302, such as one or more of a mobile phone, a laptop computer, a tablet computer or any other type of device typically used by an employee that is enable with a radio that is able to communicate with the transmit/receive network 315. The device 340 may be one or more of devices such as office devices like a printer or copier or machinery like a forklift or an autonomous robot in a smart warehouse that are typically confined to the business location 302 and are not easily moved from the location, but that are enabled with a radio that is able to communicate with the transmit/receive network 315. The additional devices 350 may include any other type of device implemented at the business location 302 that are able to communicate with the transmit/receive network 315. As illustrated, the device 330 includes a cellular radio 331 and the device 340 includes a cellular radio 341. While not illustrated, each of the additional devices 350 also include a cellular radio. The cellular radios 331, 341, and those radios of the additional devices 350 are configured to communicate with the transmit/receive network 315 of the core enterprise network 310. Thus, if the transmit/receive network 315 was configured as a 5G network, then the radios 331, 341, and those radios of the additional devices 350 would be configured as 5G radios.

13 Docket No: 16192.791

While use of the private cellular network 300 provides many advantages to the business entity 301 in terms of network speed and bandwidth, it also provides unique challenges that are not found in existing Wi-Fi networks and other similar networks typically used in a business location. For example, the normal way of authenticating a device onto a cellular network is to provide each device with a SIM ahead of time as previously described. However, because the private cellular network 300 is intended for limited use, any SIMs such as those provided by the operator of public cellular network 100 that may be present on one or more of the devices 330, 340, and 350 would likely not be useable as they would be associated with the public cellular network 100. Alternatively, the business entity 301 may be involved in a sensitive business requiring enhanced security and may only allow the devices 330, 340, and 350 to be used at the business location 302. Thus, the business entity 301 would have to produce and then install SIMs specific to the private cellular network 300 on each device 330, 340, and 350. This can be time consuming and expensive.

Some of the devices 330, 340, and 350 could have an eSIM installed on them and thus could potentially receive an eSIM profile specific to the private cellular network. However, as mentioned above, the private cellular network 300 is intended to be the only network infrastructure implemented in the business location 302. Accordingly, this would make it difficult to send an eSIM profile to the devices 330, 340, and 350 since there is no other network such as a Wi-Fi network over which the eSIM profiles could be sent.

One possible option would be to allow the devices 330, 340, and 350 to utilize the “attach” ability (also referred to as “emergency attach” previously) of the private cellular network 300 that allows access to the core enterprise network 310 with a SIM or an eSIM. As mentioned previously, the business entity 301 could allow full access to the core enterprise network 310 to a device using an attach to allow the device access to the other services 320 or even to provide an eSIM profile. However, currently there is no way to authenticate the device to the core enterprise network 310 when using emergency attach. Thus, the core enterprise network would be left open to security issues or to bad actors.

Advantageously, the embodiments disclosed herein provide for systems and methods whereby an attach is allowed, and an authentication is initiated to enable registration on the core enterprise network 310. In this way, the business entity 301 is able to implement the private cellular network 300, thus benefiting from the advantages of such networks, while still being able to ensure that the network is properly secure.

C.1. Attach Using Device ID

FIG. 3B illustrates an embodiment of the private cellular network 300 discussed in relation to FIG. 3A. Accordingly, not all the elements of FIG. 3A need be discussed in relation to FIG. 3B. In addition, although only device 330 is described in FIG. 3B, the discussion of device 330 may also apply to device 340 and the additional devices 350.

As illustrated, the device 330 does not include a SIM or an eSIM that can be used to authenticate the device to the core enterprise network 310. The device 330, however, does include a device identifier 332, which may be the IMEI that is specific to the device 330. As shown at 303, the device 330 uses the radio 331 to provide the device identifier 332 as part of an attach request to the core enterprise network 310. The authentication service 311 then verifies if the device identifier 332 is registered with the core network 110. If the device identifier 332 is registered, as is the case in the present embodiment as represented by the authentication service 311 having a record of the device identifier 332, then the device 330 is “attached” to the core enterprise network 310.

Once the device 330 is attached, the authentication service 311 or some other element of the core enterprise network 310 presents the device 330 with a captive portal 312. As previously described, the captive portal 312, which may also be referred to as a limited access portal, limits the device 330 to a logon portal and otherwise prevents use of the core enterprise network 310 to access the other network services 320. As shown at 304, the device 330 provides user authentication credentials 333 to the captive portal. The user authentication credentials 333 may include a username or an email address and a password that are specific to the user of the device 330. Alternatively, the user authentication credentials 333 may include a network certificate.

The authentication service 311 verifies that the user authentication credentials 333 are included in a register 313. In the present embodiment, the user authentication credentials 333 were previously registered as represented by the user authentication credentials 333 being included in the register 313. Once the device 330 has been authenticated, the device 330 is released from the captive portal 312. As shown at 325, the device 330 is then able to fully access the network services 320.

The authentication service 311 also updates the registration 313 to link the device identifier 332 with the user authentication credentials 333. Accordingly, as shown at 305, when the device 330 attaches again after disconnecting with the core enterprise network 310, the device 330 is automatically authenticated based on the linkage of the device identifier 332 and the user authentication credentials in the register 313 and is given full access to the other network services 320.

Accordingly, the embodiment of FIG. 3B provides a novel way for a private cellular network to provide a secure authentication of a device not having a SIM or eSIM installed. That is, existing private cellular networks are not configured to provide for a captive portal that operates in the manner described herein to authenticate a device communicating with the network without a SIM. A device is such a network must either have a SIM installed on the device or must have access to an alternative network to receive an eSIM before being able to communicate with the network. Thus, the embodiment of FIG. 3B allows for devices to securely communicate with the private cellular network without the owner of the private cellular network needing to spend the time and costs of ensuring that a SIM is installed on each device.

C.2. Attach For Providing an eSIM Profile

FIG. 3C illustrates a further embodiment of the private cellular network 300 discussed in relation to FIGS. 3A and 3B. Accordingly, not all the elements of FIG. 3A and 3B need be discussed in relation to FIG. 3C. In addition, although only device 330 is described in FIG. 3C, the discussion of device 330 may also apply to device 340 and the additional devices 350.

In the embodiment of FIG. 3C, the device 330 does not have a SIM, but does have an eSIM 316 that has not yet received an eSIM profile. Accordingly, the device 330 attaches to the core enterprise network 310, is authenticated using the captive portal 312, and is included in the updated registration 313 in the manner previously described in relation to FIG. 3B. In the embodiment of FIG. 3C, however, the core enterprise network 310 includes an eSIM profile generator 314 that is able to automatically generate an eSIM profile 317 when the device 330 first attaches to the core enterprise network 310. As shown at 306, the core network provides the eSIM profile 317 to device 330, where it is used to program the eSIM 316.

Accordingly, as shown at 307, when the device 330 attaches again after disconnecting with the core enterprise network 310, the device 330 provides the eSIM profile 317 to the authentication service 311. The authentication service 311 may then use the eSIM profile 317 to authenticate the device 330 to the core enterprise network 310 so that the device 330 is given full access to the other network services 320.

Accordingly, the embodiment of FIG. 3C provides a novel way for a private cellular network to provide an eSIM profile to a device without the need for the device to first access a separate network such as a Wi-Fi network. Existing private cellular networks require the use of a separate network to provide an eSIM profile. Accordingly, the embodiment of FIG. 3C removes the need to implement a separate network to provide an eSIM profile to the device, thus saving on the costs associated with implementing the separate network.

C.3. eSIM As Storage For Network Authentication Certificate

FIG. 3D illustrates a further embodiment of the private cellular network 300 discussed in relation to FIGS. 3A, 3B, and 3C. Accordingly, not all the elements of FIGS. 3A, 3B, and 3C need be discussed in relation to FIG. 3D. In addition, although only device 330 is described in FIG. 3D, the discussion of device 330 may also apply to device 340 and the additional devices 350.

In the embodiment of FIG. 3D, the device 330 does not have a SIM, but does have an eSIM 316 that has not yet received an eSIM profile. Accordingly, the device 330 attaches to the core enterprise network 310, is authenticated using the captive portal 312, and is included in the updated registration 313 in the manner previously described in relation to FIG. 3B.

In the embodiment of FIG. 3D, however, the core enterprise network 310 includes an authentication certificate generator 318 that is able to automatically generate a network authentication certificate 319 when the device 330 first attaches to the core enterprise network 310. The network authentication certificate 319 may be similar to a WPA2/3 certificate and may include data that identifies the device 330 and provides additional data such as keys that can be used to authenticate the device 330.

As shown at 308, the core network provides the network authentication certificate 319 to device 330. The network authentication certificate 319 may then be stored in a secure memory location of the eSIM 316. In one embodiment, the network authentication certificate 319 may be stored as Java applet.

Accordingly, as shown at 309, when the device 330 attaches again after disconnecting with the core enterprise network 310, the device 330 provides the network authentication certificate 319 to the authentication service 311. The authentication service 311 may then use the network authentication certificate 319 to authenticate the device 330 to the core enterprise network 310 so that the device 330 is given full access to the other network services 320.

It will be appreciated that storing the authentication certificate 319 on the eSIM 316 does not cause the eSIM to function as a SIM in the manner that the eSIM profile 317 does. Rather, since the eSIM already has the secure area and because the eSIM is already configured to interact with the core enterprise network 310, the eSIM is a convenient place to store the authentication certificate 319.

Accordingly, the embodiment of FIG. 3D provides a novel way for a private cellular network to use the functionality of an authentication certificate, but without the need for a separate network such as a Wi-Fi network. Rather, the network utilizes the built-in capabilities of the eSIM to store the authentication certificate and to then interact with the core network to authenticate the device 330.

Accordingly, the embodiments discussed in relation to FIGS. 3A-3D all provide novel and advantageous ways for the device 330 to identified and authorized to use the private cellular network 300 without the need for a pre-provisioned SIM and without the need to pre-connect to a different network such as a Wi-Fi network. This provides the cost and time savings previously described. In addition, the embodiments disclosed herein simply the process of adding new devices to a private cellular network as the new device need only attach and then be registered to the network in the manner previously described.

D. Example Methods

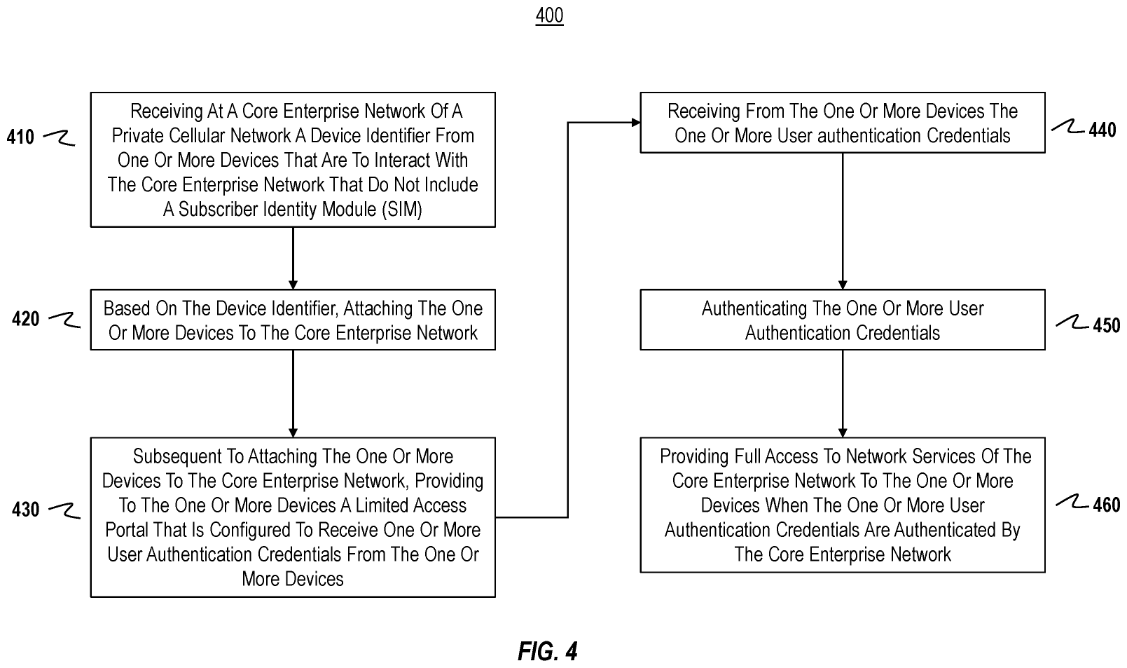

It is noted with respect to the disclosed methods, including the example method of FIG. 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 4, an example method 400 for provisioning a device in a private cellular network is disclosed. The method 400 will be described in relation to one or more of the figures previously described, although the method 400 is not limited to any particular embodiment.

The method 400 includes receiving at a core enterprise network of a private cellular network a device identifier from one or more devices that are to interact with the core enterprise network that do not include a Subscriber Identity Module (SIM) (410). For example, as previously described, the core enterprise network 310 receives the user identifier 332 from the device 330 when the device 330 does not include a SIM.

The method 400 includes, based on the device identifier, attaching the one or more devices to the core enterprise network (420). For example, as previously described the core enterprise network 310 allows the device 330 to attach to the private cellular network 300 when authentication service authenticates the device identifier.

The method 400 includes subsequent to attaching the one or more devices to the core enterprise network, providing to the one or more devices a limited access portal that is configured to receive one or more user authentication credentials from the one or more devices (430). For example, as previously described the core enterprise network 310 provides the captive portal 312 to the device 330.

The method 400 includes receiving from the one or more devices the one or more user authentication credentials (440). For example, as previously described the captive portal 312 receives the user authentication credentials 333.

The method 400 includes authenticating the one or more user authentication credentials (450). For example, as previously described the authentication service 311 authenticates the user authentication credentials 333.

The method 400 includes providing full access to network services of the core enterprise network to the one or more devices when the one or more user authentication credentials are authenticated by the core enterprise network, wherein the interactions between the core enterprise network and the one or more devices are done using the transmit and receive infrastructure of the private cellular network (460). For example, as previously described the core enterprise network 310 provides full access to the other network services 320 when the device 330 is authenticated. As discussed, the interactions between the core enterprise network 310 and the device 330 are all done using the infrastructure of the transmit and receive network 315 and do not require another network such as a Wi-Fi network.

E. Further Example Embodiments

Following are some further example embodiments of the invention. These are presented only by way of example and are not intended to limit the scope of the invention in any way.

Embodiment 1. A method, comprising: receiving at a core enterprise network of a private cellular network a device identifier from one or more devices that are to interact with the core enterprise network that do not include a Subscriber Identity Module (SIM); based on the device identifier, attaching the one or more devices to the core enterprise network; subsequent to attaching the one or more devices to the core enterprise network, providing to the one or more devices a limited access portal that is configured to receive one or more user authentication credentials from the one or more devices; receiving from the one or more devices the one or more user authentication credentials; authenticating the one or more user authentication credentials; and providing full access to network services of the core enterprise network to the one or more devices when the one or more user authentication credentials are authenticated by the core enterprise network, wherein the interactions between the core enterprise network and the one or more devices are done using the transmit and receive infrastructure of the private cellular network.

Embodiment 2. The method of embodiment 1, further comprising linking the device identifier to the one or more user authentication credentials; and automatically providing full access to the network services based on the linking when the one or more devices disconnect from and then subsequently are attached again to the core enterprise network.

Embodiment 3. The method of embodiments 1-2, wherein the device identifier

includes the International Mobile Equipment Identity (IMEI).

Embodiment 4. The method of embodiment 1-3, wherein the one or more user authentication credentials include one or more of an email address, a username, a password, or a network authentication certificate.

Embodiment 5. The method of embodiments 1-4, wherein the transmit and receive infrastructure of the private cellular network is configured for one of 4G LTE or 5G.

Embodiment 6. The method of embodiments 1-5, wherein the one or more devices, while not including the SIM, do include an embedded-SIM (eSIM), the method further comprising: subsequent to authenticating the one or more user authentication credentials, generating at an eSIM generator of the core enterprise network an eSIM profile; and providing the eSIM profile to the one or more devices, the eSIM profile configured to cause the eSIM to function as a SIM, wherein the eSIM profile is provided to the one or more devices using the transmit and receive infrastructure of the private cellular network and without the need for a separate network.

Embodiment 7. The method of embodiment 6, wherein the eSIM profile includes the International Mobile Subscriber Identity (IMSI).

Embodiment 8. The method of embodiment 6, further comprising: receiving the eSIM profile from the one or more devices when the one or more devices disconnect from and subsequently are attached again to the core enterprise network; and automatically providing full access to the network services based on the received eSIM profile.

Embodiment 9. The method of embodiments 1-8, wherein the one or more devices, while not including the SIM, do include an embedded-SIM (eSIM), the method further comprising: subsequent to authenticating the one or more user authentication credentials, generating at an authentication certificate generator of the core enterprise network a network authentication certificate; and providing the network authentication certificate to the one or more devices, the network authentication certificate configured to be stored in a secure memory location of the eSIM, wherein the network authentication certificate is provided to the one or more devices using the transmit and receive infrastructure of the private cellular network and without the need for a separate network.

Embodiment 10. The method of embodiment 9, further comprising: receiving the network authentication certificate from the one or more devices when the one or more devices disconnect from and subsequently are attached again to the core enterprise network; and

automatically providing full access to the network services based on the received network authentication certificate.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer- executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non- transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, or the like may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

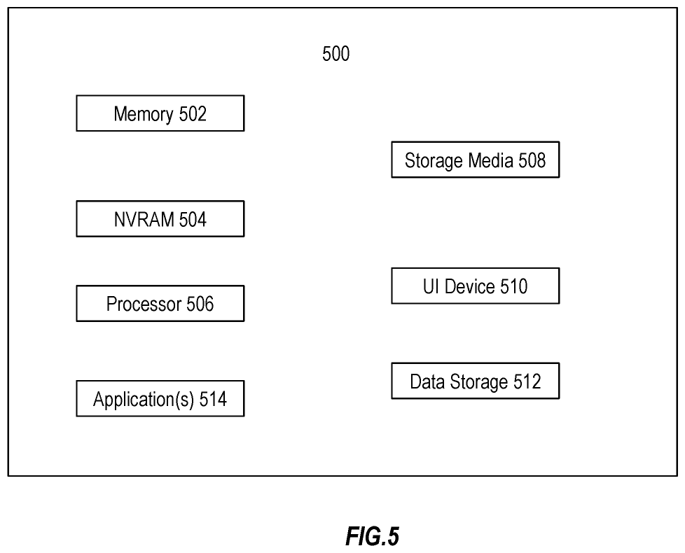

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. Also, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the components of the memory 502 of the physical computing device 500 may take the form of solid-state device (SSD) storage. Also, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving at a core enterprise network of a private cellular network a device identifier from one or more devices that are to interact with the core enterprise network that do not include a Subscriber Identity Module (SIM);
based on the device identifier, attaching the one or more devices to the core enterprise network;
subsequent to attaching the one or more devices to the core enterprise network, providing to the one or more devices a limited access portal that is configured to receive one or more user authentication credentials from the one or more devices;
receiving from the one or more devices the one or more user authentication credentials;
authenticating the one or more user authentication credentials; and
providing full access to network services of the core enterprise network to the one or more devices when the one or more user authentication credentials are authenticated by the core enterprise network,
wherein the interactions between the core enterprise network and the one or more devices are done using a transmit and receive infrastructure of the private cellular network.

2. The method of claim 1, further comprising:
linking the device identifier to the one or more user authentication credentials; and automatically providing full access to the network services based on the linking when the one or more devices disconnect from and then subsequently are attached again to the core enterprise network.

3. The method of claim 1, wherein the device identifier includes an International Mobile Equipment Identity (IMEI).

4. The method of claim 1, wherein the one or more user authentication credentials include one or more of an email address, a username, a password, or a network authentication certificate.

5. The method of claim 1, wherein the transmit and receive infrastructure of the private cellular network is configured for one of 4G LTE or 5G.

6. The method of claim 1, wherein the one or more devices, while not including the SIM, do include an embedded-SIM (eSIM), the method further comprising:
subsequent to authenticating the one or more user authentication credentials, generating at an eSIM generator of the core enterprise network an eSIM profile; and
providing the eSIM profile to the one or more devices, the eSIM profile configured to cause the eSIM to function as a SIM,
wherein the eSIM profile is provided to the one or more devices using the transmit and receive infrastructure of the private cellular network and without a need for a separate network.

7. The method of claim 6, wherein the eSIM profile includes an International Mobile Subscriber Identity (IMSI).

8. The method of claim 6, further comprising:
receiving the eSIM profile from the one or more devices when the one or more devices disconnect from and subsequently are attached again to the core enterprise network; and
automatically providing full access to the network services based on the received eSIM profile.

9. The method of claim 1, wherein the one or more devices, while not including the SIM, do include an embedded-SIM (eSIM), the method further comprising:
subsequent to authenticating the one or more user authentication credentials, generating at an authentication certificate generator of the core enterprise network a network authentication certificate; and
providing the network authentication certificate to the one or more devices, the network authentication certificate configured to be stored in a secure memory location of the eSIM,
wherein the network authentication certificate is provided to the one or more devices using the transmit and receive infrastructure of the private cellular network and without a need for a separate network.

10. The method of claim 9, further comprising:
receiving the network authentication certificate from the one or more devices when the one or more devices disconnect from and subsequently are attached again to the core enterprise network; and
automatically providing full access to the network services based on the received network authentication certificate.

11. A non-transitory storage medium having stored therein instructions that are executable by one or more hardware processors to perform operations comprising:
receive at a core enterprise network of a private cellular network a device identifier from one or more devices that are to interact with the core enterprise network that do not include a Subscriber Identity Module (SIM);
based on the device identifier, attach the one or more devices to the core enterprise network;
subsequent to attaching the one or more devices, provide to the one or more devices a limited access portal that is configured to receive one or more user authentication credentials from the one or more devices;
receive from the one or more devices the one or more user authentication credentials;
authenticate the one or more user authentication credentials; and
provide full access to network services of the core enterprise network to the one or more devices when the one or more user authentication credentials are authenticated by the core enterprise network,
wherein the interactions between the core enterprise network and the one or more devices are done using a transmit and receive infrastructure of the private cellular network.

12. The non-transitory storage medium of claim 11, further comprising the following operations:
linking the device identifier to the user authentication credentials; and
automatically providing full access to the network services based on the linking when the one or more devices disconnect from and then subsequently are attached again to the core enterprise network.

13. The non-transitory storage medium of claim 11, wherein the device identifier includes an International Mobile Equipment Identity (IMEI).

14. The non-transitory storage medium of claim 11, wherein the one or more user authentication credentials include one or more of an email address, a username, a password, or a network authentication certificate.

15. The non-transitory storage medium of claim 11, wherein the transmit and receive infrastructure of the private cellular network is configured for one of 4G LTE or 5G.

16. The non-transitory storage medium of claim 11, wherein the one or more devices, while not including the SIM, do include an embedded-SIM (eSIM), further comprising the following operations:
subsequent to authenticating the one or more user authentication credentials, generating at an eSIM generator of the core enterprise network an eSIM profile; and
providing the eSIM profile to the one or more devices, the eSIM profile configured to cause the eSIM to function as a SIM,
wherein the eSIM profile is provided to the one or more devices using the transmit and receive infrastructure of the private cellular network and without a need for a separate network.

17. The non-transitory storage medium of claim 16, wherein the eSIM profile includes an International Mobile Subscriber Identity (IMSI).

18. The non-transitory storage medium of claim 16, further comprising the following operations:
receiving the eSIM profile from the one or more devices when the one or more devices disconnect from and subsequently are attached again to the core enterprise network; and
automatically providing full access to the network services based on the received eSIM profile.

19. The non-transitory storage medium of claim 11, wherein the one or more devices, while not including the SIM, do include an embedded-SIM (eSIM), further comprising the following operations:
subsequent to authenticating the one or more user authentication credentials, generating at an authentication certificate generator of the core enterprise network a network authentication certificate; and
providing the network authentication certificate to the one or more devices, the network authentication certificate configured to be stored in a secure memory location of the eSIM,
wherein the network authentication certificate is provided to the one or more devices using the transmit and receive infrastructure of the private cellular network and without a need for a separate network.

20. The non-transitory storage medium of claim 19, further comprising the following options:
receiving the network authentication certificate from the one or more devices when the one or more devices disconnect from and subsequently are attached again to the core enterprise network; and
automatically providing full access to the network services based on the received network authentication certificate.
